(19) United States
(12) Patent Application Publication
(10) Pub. No.: US 2024/0258580 A1
(43) Pub. Date: Aug. 1, 2024

(54) METHOD FOR MANUFACTURING WOUND ELECTRODE BODY, METHOD FOR MANUFACTURING STORAGE DEVICE INCLUDING THE WOUND ELECTRODE BODY, AND WOUND ELECTRODE BODY MANUFACTURING DEVICE FOR THE SAME

(71) Applicant: Prime Planet Energy & Solutions, Inc., Tokyo (JP)

(72) Inventors: Yuko NOWATARI, Kobe-shi (JP); Koji NIHOMMATSU, Sumoto-shi (JP)

(21) Appl. No.: 18/423,303

(22) Filed: Jan. 26, 2024

(30) Foreign Application Priority Data
Feb. 1, 2023 (JP) 2023-014087

(51) Int. Cl. H01M 10/0587; B65H 18/28

(52) U.S. Cl. CPC H01M 10/0587; B65H 18/28; B65H 2701/10

(57) ABSTRACT

A method for manufacturing a wound electrode body disclosed herein includes preparing a positive electrode sheet, a negative electrode sheet, and a separator sheet, conveying each of the prepared sheets, and winding each of the conveyed sheets around a core. In the preparing, an adhesion layer is arranged on at least one sheet of the sheets. In the conveying, the sheet on which the adhesion layer is arranged is conveyed such that a region where the adhesion layer is not arranged contacts a roller.

### CROSS REFERENCE OF RELATED APPLICATION

This application claims the benefit of priority to Japanese Patent Application No. 2023-014087 filed on Feb. 1, 2023. The entire contents of this application are hereby incorporated herein by reference.

### BACKGROUND OF THE DISCLOSURE

### 1. Field

The present disclosure relates to a method for manufacturing a wound electrode body, a method for manufacturing a storage device including the wound electrode body, and a wound electrode body manufacturing device for the wound electrode body.

### 2. Background

For example, Japanese Patent Application Publication No. 2008-152946 discloses a method for manufacturing a wound electrode body including a strip-shaped positive electrode sheet, a strip-shaped negative electrode sheet, and a strip-shaped separator sheet that are wound in a spiral shape such that the separator sheet is interposed between the positive electrode sheet and the negative electrode sheet, the method including winding the positive electrode sheet, the negative electrode sheet, and the at least one separator sheet while continuously removing a foreign matter adhered to a component sheet in a non-contact state.

### SUMMARY

Incidentally, in recent years, in order to prevent misalignment of an electrode sheet and a separator sheet in a wound electrode body or the like, an adhesion layer is arranged on a surface of the electrode sheet and/or the separator sheet in some cases. According to an examination of the inventors of the present disclosure, it was found that there is a probability that, for example, in manufacturing a wound electrode body using an electrode sheet or a separator sheet on which an adhesion layer is arranged, the adhesion layer is adhered to a roller (a guide roller) arranged on a conveyance path on which the sheet on which the adhesion layer is arranged is conveyed to a winding core. This might cause adhesion of a foreign matter to the sheet, reduction in adhesive strength of the adhesion layer, or the like, and therefore, the above-described arrangement of the adhesion layer is not preferable from a viewpoint of productivity.

In view of the foregoing, the present disclosure has been devised and it is therefore a major object of the present disclosure to provide a technology that can preferably increase, in a wound electrode body including an electrode sheet and a separator sheet that include an adhesion layer, productivity of the wound electrode body and a storage device including the wound electrode body.

In order to achieve the above-described object, the present disclosure provides a method for manufacturing a wound electrode body, the wound electrode body being configured such that a strip-shaped positive electrode sheet and a strip-shaped negative electrode sheet are stacked with a strip-shaped separator sheet interposed therebetween and an obtained stacked body is wound and that the separator sheet and the positive electrode sheet are bonded via an adhesion layer and/or the separator sheet and the negative electrode sheet are bonded via the adhesion layer, the method including preparing the positive electrode sheet, the negative electrode sheet, and the at least one separator sheet, conveying each of the prepared sheets, and winding each of the conveyed sheets around a winding core. In the method, in the preparing, at least one sheet of the positive electrode sheet, the negative electrode sheet, and the separator sheet includes the adhesion layer on at least one surface thereof and the surface including the adhesion layer includes a region where the adhesion layer is arranged and a region where the adhesion layer is not arranged, and in the conveying, the sheet including the adhesion layer is conveyed such that the region where the adhesion layer is not arranged contacts a roller. Although details of the method will be described below, according to the method for manufacturing a wound electrode body having the above-described configuration, productivity of a wound electrode body can be increased.

According to another aspect, the present disclosure provides a method for manufacturing a storage device, in which a storage device is constructed using a wound electrode body obtained by any one of methods for manufacturing a wound electrode body disclosed herein. According to the method for manufacturing a storage device having the above-described configuration, productivity of a storage device including a wound electrode body can be increased.

According to still another aspect, the present disclosure provides a wound electrode body manufacturing device for a wound electrode body configured such that a strip-shaped positive electrode sheet and a strip-shaped negative electrode sheet are stacked with a strip-shaped separator sheet interposed therebetween and an obtained stacked body is wound and that the separator sheet and the positive electrode sheet are bonded via an adhesion layer and/or the separator sheet and the negative electrode sheet are bonded via the adhesion layer, the device including a conveying section that conveys the positive electrode sheet, the negative electrode sheet, and the separator sheet, a roller configured to contact a region where the adhesion layer is not arranged in one sheet of the positive electrode sheet, the negative electrode sheet, and the separator sheet that includes the adhesion layer, and a winding core around which the sheets conveyed by the conveying section are wound. Although details of the wound electrode body manufacturing device will be described below, according to the wound electrode body manufacturing having the above-described configuration, productivity of a wound electrode body can be increased.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a block diagram schematically illustrating a wound electrode body manufacturing device according to a first preferred embodiment.

FIG. 2 is a schematic diagram illustrating an aspect of a front surface of a second separator sheet according to the first preferred embodiment in a plan view and a configuration of a roller.

FIG. 3 is a schematic diagram illustrating an aspect of a back surface of the second separator sheet according to the first preferred embodiment in a plan view and a configuration of the roller.

FIG. 4A is a schematic diagram illustrating a configuration of a roller according to the first preferred embodiment.

FIG. 4B is a schematic diagram illustrating a configuration of a roller according to the first preferred embodiment.

FIG. 5 is a flowchart illustrating a method for manufacturing a wound electrode body according to the first preferred embodiment.

FIG. 6 is a perspective view schematically illustrating a battery according to the first preferred embodiment.

FIG. 7 is a schematic longitudinal sectional view taken along line VII-VII in FIG. 6.

FIG. 8 is a schematic longitudinal sectional view taken along line VIII-VIII in FIG. 6.

FIG. 9 is a schematic cross-sectional view taken along line IX-IX in FIG. 6.

FIG. 10 is a perspective view schematically illustrating the wound electrode body mounted on a sealing plate.

FIG. 11 is a perspective view schematically illustrating the wound electrode body on which a positive electrode second current collector and a negative electrode second current collector are mounted.

FIG. 12 is a schematic diagram illustrating a configuration of the wound electrode body of the battery according to the first preferred embodiment.

FIG. 13 is an enlarged view schematically illustrating an interface between a positive electrode sheet, a negative electrode sheet, and a separator sheet according to the first preferred embodiment.

FIG. 14 is a diagram according to a second preferred embodiment, corresponding to FIG. 2.

FIG. 15 is a diagram according to a third preferred embodiment, corresponding to FIG. 2.

FIG. 16 is a diagram according to a fourth preferred embodiment, corresponding to FIG. 2.

FIG. 17 is a diagram according to a fifth preferred embodiment, corresponding to FIG. 2.

FIG. 18 is a diagram according to a sixth preferred embodiment, corresponding to FIG. 2.

FIG. 19 is a diagram according to a seventh preferred embodiment, corresponding to FIG. 2.

FIG. 20 is a diagram according to an eighth preferred embodiment, corresponding to FIG. 2.

### DETAILED DESCRIPTION OF THE PREFERRED EMBODIMENTS

Preferred embodiments of a technology disclosed herein will be described below with reference to the accompanying drawings. In the drawings described below, the members and parts with the same operation are denoted by the same reference signs. A dimensional relation (of length, width, thickness, or the like) in each of the drawings does not necessarily reflect an actual dimensional relation. Note that matters other than matters specifically mentioned in this specification and necessary for carrying out the technology discussed herein (for example, general configuration and manufacturing process of a battery that do not characterize the present disclosure) can be understood as design matters for those skilled in the art based on the related art in the related field. The technology disclosed herein can be carried out based on contents disclosed in this specification and the common general technical knowledge in the field. Note that, in this specification, the notation “A to B” that indicates a range means “A or more and B or less.” The notation also includes “a range that exceeds A” and “a range less than B.”

Note that, as used in this specification, the term “storage device” refers to a power device that can perform charging and discharging. Storage devices (power storage devices) include batteries, such as a primary battery, a secondary battery (for example, a lithium-ion secondary battery, a nickel-hydrogen battery), or the like, and capacitors (physical batteries), such as an electric double layer capacitor or the like. An electrolyte may be any one of a liquid electrolyte (an electrolytic solution), a gel electrolyte, and a solid electrolyte. Note that the present technology will be described below using, as an example, a lithium-ion secondary battery that is one preferred embodiment of the storage device.

Note that a case where, of a positive electrode sheet 22, a negative electrode sheet 24, and a separator sheet 26 (in this case, a first separator sheet 26S₁ and a second separator sheet 26S₂), an adhesion layer 6 is arranged on the second separator sheet 26S₂, and furthermore, the adhesion layer 6 is arranged on both surfaces (first and second surfaces) of the second separator sheet 26S₂ will be described below as an example. In the technology disclosed herein, a sheet (in this case, the second separator sheet 26S₂) including the adhesion layer 6 provided thereon in advance can be used, but a case where the adhesion layer 6 is formed on a surface of a sheet (in this case, the separator sheet 26S₂) by an adhesion layer application section 5 will be described below. As a matter of course, there is no intension to limit the technology disclosed herein to the following preferred embodiments.

### Wound Electrode Body Manufacturing Device 1

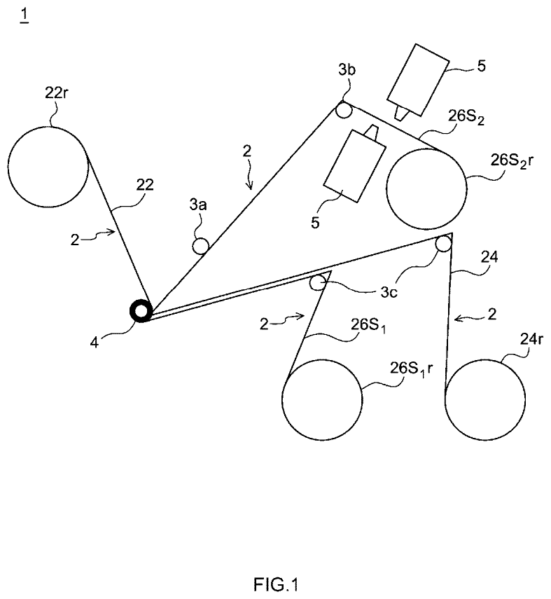

First, a wound electrode body manufacturing device 1 according to a first preferred embodiment will be described. Herein, FIG. 1 is a block diagram schematically illustrating the wound electrode body manufacturing device 1 according to the first preferred embodiment. The wound electrode body manufacturing device 1 is a device that manufactures a wound electrode body (in this case, wound electrode bodies 20a, 20b, and 20c) in which a strip-shaped positive electrode sheet 22 and a strip-shaped negative electrode sheet 24 are stacked with a strip-shaped separator sheet 26 interposed therebetween and an obtained stacked body is wound (which can be also referred to as a wound electrode body including a strip-shaped positive electrode sheet 22, a strip-shaped negative electrode sheet 24, and a strip-shaped separator sheet 26 that provides insulation therebetween) and in which the separator sheet 26 and the positive electrode sheet 22 are bonded via an adhesion layer 6 and/or the separator sheet 26 and the negative electrode sheet 24 are bonded via the adhesion layer 6. Note that, hereinafter, a width direction of a strip-shaped sheet will be sometimes referred to as a transverse direction and a direction orthogonal to the width direction will be sometimes referred to as a longitudinal direction. As illustrated in FIG. 1, the wound electrode body manufacturing device 1 of this preferred embodiment includes a conveying section 2 that conveys the strip-shaped positive electrode sheet 22, the strip-shaped negative electrode sheet 24, and the strip-shaped separator sheet 26, one or more rollers (in this case, rollers 3a and 3b) configured to contact a region where the adhesion layer 6 is not arranged in the sheet (in this case, the second separator sheet 26S₂) of the strip-shaped positive electrode sheet 22, the strip-shaped negative electrode sheet 24, and the strip-shaped separator sheet 26 that includes the adhesion layer 6, and a winding core 4 around which the positive electrode sheet 22, the negative electrode sheet 24, and the separator sheet 26 that have been conveyed by the conveying section 2 is wound. The wound electrode body manufacturing device 1 according to this preferred embodiment further includes an adhesion layer application section 5 used for arranging the adhesion layer 6 on at least one surface (in this case, both surface of the second separator sheet 26S₂) of at least one of the positive electrode sheet 22, the negative electrode sheet 24, and the separator sheet 26.

According to the wound electrode body manufacturing device 1 having the above-described configuration, for example, adhesion of the adhesion layer 6 arranged on the sheet (in this case, the second separator sheet 26S₂) to the roller (in this case, the rollers 3a and 3b) can be preferably suppressed. Thus, adhesion of a foreign matter to the sheet (in this case, the second separator sheet 26S₂), reduction in adhesive strength of the adhesion layer 6, or the like can be preferably suppressed, and therefore, productivity of a wound electrode body and a storage device (for example, a battery) including the wound electrode body can be preferably increased.

The wound electrode body manufacturing device 1 preferably includes, for example, a cutter, a pressing jig, and a controller. Herein, the cutter is used for cutting each of the above-described sheets into a desired length. The pressing jig presses each of the sheets to the winding core 4. Each component of the wound electrode body manufacturing device 1 preferably includes a necessary actuator as appropriate. The controller is configured to control each component of the wound electrode body manufacturing device 1 such that a necessary operation is executed at a predetermined timing in accordance with a preset program. The controller can be embodied by a computer, such as, for example, a microcontroller. Each component will be described in detail below.

### Conveying Section 2

As illustrated in FIG. 1, the conveying section 2 conveys each of the positive electrode sheet 22, the negative electrode sheet 24, and the separator sheet 26 (in this case, the first separator sheet 26S₁ and second separator sheet 26S₂). Each of the sheets is conveyed to the winding core 4 by the conveying section 2. Each of the sheets can be prepared in a state of being wound by a reel or the like. As illustrated in FIG. 1, in this preferred embodiment, the positive electrode sheet 22, the negative electrode sheet 24, the first separator sheet 26S₁, and the second separator sheet 26S₂ are wound by reels 22r, 24r, 26S₁r, and 26S₂r, respectively. The conveying section 2 may include a dancer roll mechanism that removes looseness of the positive electrode sheet 22, the negative electrode sheet 24, the first separator sheet 26S₁, and the second separator sheet 26S₂ that are sent out, a tensioner that adjusts a tension, or the like.

### Rollers 3a and 3b

As illustrated in FIG. 1, the wound electrode body manufacturing device 1 according to this preferred embodiment includes rollers 3a and 3b configured to contact a region where the adhesion layer 6 is not arranged in the second separator sheet 26S₂ of the sheets that includes the adhesion layer 6. Herein, the roller 3a contacts a front surface (first surface) of the second separator sheet 26S₂ and the roller 3b contacts a back surface (second surface) of the second separator sheet 26S₂ such that the separator sheet 26S₂ is sandwiched therebetween. The wound electrode body manufacturing device 1 according to this preferred embodiment includes two rollers that have the above-described configuration, but in other preferred embodiments, the wound electrode body manufacturing device 1 may include only one roller that has the above-described configuration, and may include three or more rollers that have the above-described configuration. In a case where the adhesion layer 6 is arranged on an electrode sheet, a roller that has the above-described configuration may be used for the electrode sheet. In addition to the roller that has the above-described configuration, the wound electrode body manufacturing device 1 may further include a roller used for conveying each of the above-described sheets. For example, in this preferred embodiment, the wound electrode body manufacturing device 1 includes, in addition to the rollers 3a and 3b, a roller 3c that conveys each of the first separator sheet 26S₁ and the negative electrode sheet 24. Note that only at least the sheet including the adhesion layer 6 may be conveyed by the rollers.

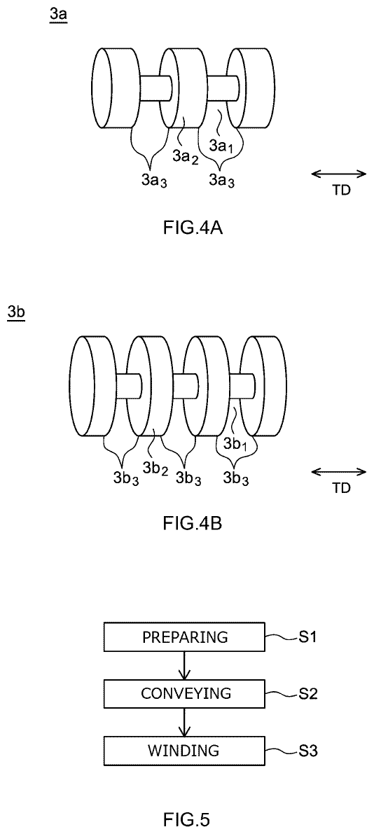

The wound electrode body manufacturing device 1 disclosed herein may include at least a roller (in this case, the rollers 3a and 3b) configured to contact a region where the adhesion layer 6 is not arranged in the sheet (in this case, the second separator sheet 26S₂) of the sheets that includes the adhesion layer 6. On the other hand, as for a relationship between the region where the adhesion layer 6 is arranged and the roller (in this case, the rollers 3a and 3b), when it is assumed that a total area of the adhesion layer 6 on one surface of the sheet (in this case, the second separator sheet 26S₂) is 100%, a ratio of an area of a portion where the roller 3a (the roller 3b) and the adhesion layer 6 contact each other is, for example, preferably 40% or less, is more preferably 30% or less, and particularly preferably 20% or less, from a viewpoint of more preferably suppressing adhesion of a foreign matter to the sheet (in this case, the second separator sheet 26S₂), reduction in adhesive strength of the adhesion layer 6, or the like. However, the ratio is not limited thereto. When the adhesion layer 6 and the roller 3a (the roller 3b) slightly contact each other, the adhesion layer 6 may contact an end portion 3a₃ (an end portion 3b₃) of the roller 3a (the roller 3b) in a TD direction (see FIG. 4A and FIG. 4B).

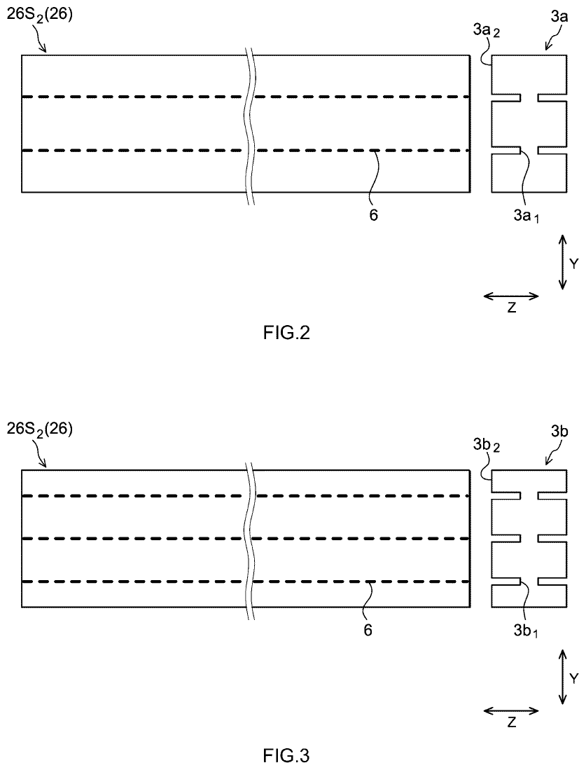

In one aspect, in the sheet including the adhesion layer, the adhesion layer is intermittently arranged in a width direction of the sheet or a longitudinal direction orthogonal to the width direction, and the roller is configured to contact a region where the adhesion layer is not intermittently arranged in the sheet including the adhesion layer. Herein, FIG. 2 is a schematic diagram illustrating an aspect of the front surface of the second separator sheet 26S₂ in a plan view and a configuration of the roller 3a. FIG. 3 is a schematic diagram illustrating an aspect of the back surface of the second separator sheet 26S₂ in a plan view and a configuration of the roller 3b. As illustrated in FIG. 2 and FIG. 3, in this preferred embodiment, on both surfaces of the second separator sheet 26S₂ including the adhesion layer 6, the adhesion layer 6 is intermittently arranged (on a line extending in a longitudinal direction) to extend in a longitudinal direction of the second separator sheet 26S₂. The rollers 3a and 3b are configured to contact the region where the adhesion layer 6 is not arranged in the second separator sheet 26S₂ including the adhesion layer 6.

Note that, in this preferred embodiment, a shape of the second separator sheet 26S₂ in a plan view is a dashed line shape, but is not limited thereto. A shape of the adhesion layer 6 in a plan view of the second separator sheet 26S₂ may be, for example, a dot shape, a stripe shape, a wave shape, a strip shape (a streak shape), or a shape obtained by combining the above-described shapes. For example, second through eighth preferred embodiments described below are other examples of the shape of the adhesion layer 6 in a plan view of the sheet. In this preferred embodiment, the number of intermittent lines arranged on the second separator sheet 26S₂ is different between the front and back surfaces of the second separator sheet 26S₂, but may be the same in other preferred embodiments. That is, arrangement positions of the adhesion layer 6 on the front and back surfaces of the sheet may be the same, and may be different from each other. The number of intermittent lines arranged on one surface of the second separator sheet 26S₂ may be one and may be plural. In this preferred embodiment, on the second separator sheet 26S₂, the adhesion layer 6 is arranged (on a line extending in the longitudinal direction) to extend in the longitudinal direction of the second separator sheet 26S₂, but is not limited thereto. The adhesion layer 6 may be arranged (on a line extending in a transverse direction) to extend in the width direction of the second separator sheet 26S₂.

In one aspect, a rotating surface of the roller is configured in a comb shape with a recessed portion and a raised portion alternately formed, and the raised portion is configured to contact a region where the adhesion layer is not arranged in the sheet including the adhesion layer. Herein, FIG. 4A and FIG. 4B are schematic diagrams illustrating respective structures of the rollers 3a and 3b. As illustrated in FIG. 4A, in this preferred embodiment, a rotating surface of the roller 3a is configured in a comb shape with a recessed portion 3a₁ and a raised portion 3a₂ alternately formed. A rotating surface of the roller 3b is configured in a comb shape with a recessed portion 3b₁ and a raised 3b₂ alternately formed. The raised portion 3a₂ and the raised portion 3b₂ are configured to contact the region where the adhesion layer 6 is not arranged in the second separator sheet 26S₂ including the adhesion layer 6. Note that a shape of the rotating surface of each of the rollers is not limited to a comb shape and each of the rollers may be in various other shapes as long as an effect of the technology disclosed herein can be achieved. For example, edge portions of the rollers 3a and 3b can be rounded. According to the above-described configuration, contact between the edge portion and the adhesion layer 6 can be preferably suppressed. Note that, for example, as for the rollers 3a and 3b each having a rotating surface with a comb shape, and as for a roller 3d that will be described later, a sheet that is conveyed can be held (sandwiched) by both end portions of each of the rollers with sufficient strength.

In one preferred aspect, the roller is configured substantially not to contact the region where the adhesion layer is arranged in the sheet including the adhesion layer. As illustrated in FIG. 2, in this preferred embodiment, the roller 3a is configured substantially not to contact the region where the adhesion layer 6 is arranged in the second separator sheet 26S₂ including the adhesion layer 6. As illustrated in FIG. 3, in this preferred embodiment, the roller 3b is configured substantially not to contact the region where the adhesion layer 6 is arranged in the second separator sheet 26S₂ including the adhesion layer 6. According to the above-described configuration, adhesion of a foreign matter to the sheet (in this case, the second separator sheet 26S₂), reduction in adhesive strength of the adhesion layer 6, or the like can be particularly preferably suppressed, and therefore, the productivity of the wound electrode body and the storage device (for example, a battery) including the wound electrode body can be preferably increased. Herein, for example, the expression “the region where the adhesion layer 6 is arranged and the roller 3a (the roller 3b) substantially do not contact each other” means that, when it is assumed that the total area of the adhesion layer 6 on one surface of the sheet (in this case, the second separator sheet 26S₂) is 100%, the ratio of the area of a potion where the roller 3a (the roller 3b) and the adhesion layer 6 contact each other is, for example, 10% or less, is preferably 5% or less, is more preferably 1% or less, and is particularly preferably 0% (that is, the sheet and the roller do not contact each other at all).

### Winding Core 4

As illustrated in FIG. 1, the winding core 4 is provided so that each of the sheets conveyed by the conveying section 2 is wound therearound. The winding core 4 has a function of holding each sheet that is wound around a circumferential surface. Herein, the winding core 4 is an approximately cylindrical member, but a flat winding core may be used when the sheets are wound into a flat shape.

### Adhesion Layer Application Section 5

The adhesion layer application section 5 is used for arranging (imparting) the adhesion layer on at least one surface of at least one sheet of the above-described sheets. The adhesion layer application section 5 can be also referred to as a device that applies a binder solution (an adhesive) to the surface of the sheet in a conveying direction. As described above, in this preferred embodiment, using the adhesion layer application section 5, the adhesion layer 6 is arranged on both surfaces of the second separator sheet 26S₂. The adhesion layer application section 5 is configured to apply a desired amount of the binder solution to a desired region of the sheet. The binder solution includes, for example, an adhesion layer binder that will be described below and a solvent. As a solvent of the binder solution, a so-called aqueous solvent is preferably used from a viewpoint of reducing an environmental load. In this case, water or a water-based mixed solvent can be used. As solvent components other than water that constitute the mixed solvent, one or two or more organic solvents (a lower alcohol, a lower ketone, or the like) that can be uniformly mixed with water can be selected as appropriate to be used. For example, use of an aqueous solvent 80 mass % or more (more preferably 90 mass % or more, and further more preferably 95 mass % or more) of which is water is preferable. A particularly preferable example is an aqueous solvent composed substantially of water. The solvent of the binder solution is not limited to so-called aqueous solvents, but may also be a so-called organic solvent-based solvent. Examples of the organic solvent-based solvent include, for example, N-methylpyrrolidone or the like. For example, as a preferred example of the binder solution, the binder solution may be obtained by mixing an acrylic resin (for example, polymethacrylate resin) as a binder with water as a solvent. Note that the binder solution may contain one or two or more additives, such as known thickeners, surfactants, or the like, in order to increase wettability for the positive electrode sheet 22, the separator sheet 26, or the like, unless the effect of the technology disclosed herein is impaired.

As the adhesion layer application section 5, various types of application devices, such as, for example, inkjet printing, various types of intaglio printing machines, such as a gravure roll coater, a spray coater, or the like, die coaters, such as a slit coater, a comma coater, a capillary coater (a CAP coater), or the like, a lip coater, a calendering machine, or the like, can be used.

Although not particularly limited, when it is assumed that the area of one surface of the sheet is 100%, an arrangement area of the adhesion layer 6 on one surface of the sheet is, for example, 5% or more. From a viewpoint of making adhesion of the electrode sheets and the separator sheets in the wound electrode body (in this case, the wound electrode bodies 20a, 20b, and 20c), the arrangement area is preferably 10% or more and may be 20% or more and 30% or more. An upper limit of the arrangement area of the adhesion layer 6 on one surface of the sheet is, for example, 60% or less, and may be 50% or less or 40% or less.

Next, one preferred embodiment of a method for manufacturing a wound electrode body (a battery including a wound electrode body) according to this preferred embodiment will be described with the wound electrode body manufacturing device 1 that embodies the method for manufacturing a wound electrode body. Herein, FIG. 5 is a flowchart illustrating the method for manufacturing a wound electrode body according to this preferred embodiment. First, the manufacturing method according to this preferred embodiment is a method for manufacturing a wound electrode body (in this case, the wound electrode bodies 20a, 20b, and 20c) configured such that a strip-shaped positive electrode sheet 22 and a strip-shaped negative electrode sheet 24 are stacked with a strip-shaped separator sheet 26 interposed therebetween and an obtained stacked body is wound (which can be also referred to as a wound electrode body including a strip-shaped positive electrode sheet 22, a strip-shaped negative electrode sheet 24, and a separator sheet 26 that provides insulation therebetween) and that the separator sheet 26 and the positive electrode sheet 22 are bonded via an adhesion layer 6 and/or the separator sheet 26 and the negative electrode sheet 24 are bonded via the adhesion layer 6. The method for manufacturing a wound electrode body includes preparing (Step S1) the positive electrode sheet 22, the negative electrode sheet 24, and the separator sheet 26, conveying (Step S2) each of the prepared sheets, and winding (Step S3) each of the conveyed sheets around a winding core 4. Note that, in the preparing, the positive electrode sheet 22, the negative electrode sheet 24, and the separator sheet 26 are prepared such that an adhesion layer 6 is arranged on at least one surface (in this case, both surfaces of a second separator sheet 26S₂) of at least one sheet of the sheets. In the conveying, the sheet including the adhesion layer 6 (in this case, the second separator sheet 26S₂) is conveyed while a region where the adhesion layer 6 is not arranged contacts a roller (in this case, rollers 3a and 3b)

According to the method for manufacturing a wound electrode body having the above-described configuration, adhesion of the adhesion layer 6 arranged on the sheet (in this case, the second separator sheet 26S₂) to the roller herein, the rollers 3a and 3b) can be preferably suppressed. Thus, adhesion of a foreign matter to the sheet (in this case, the second separator sheet 26S₂), reduction in adhesive strength of the adhesion layer 6, or the like can be preferably suppressed, and therefore, the productivity of the wound electrode body and a storage device (for example, a battery) including the wound electrode body can be preferably increased. Each process step will be described in detail below. Note that the method for manufacturing a wound electrode body disclosed herein may further include some other process step in an arbitrary stage, and one or more of the process steps can be omitted as appropriate unless the one or more of the process steps are described as essential elements. An order of the process steps can be changed as long as the effect of the technology disclosed herein is achieved.

### Step S1: Preparing

As described above, in this process step, a positive electrode sheet 22, a negative electrode sheet 24, and a separator sheet 26 are prepared. In this preferred embodiment, a first separator sheet 265₁ and a second separator sheet 26S₂ are prepared as the separator sheet. As illustrated in FIG. 2 and FIG. 3, in this preferred embodiment, the sheet including the adhesion layer 6 is the separator 26 (specifically, the second separator sheet 26S₂). Note that, in other preferred embodiments, the sheet including the adhesion layer 6 may be the positive electrode sheet 22 and may be the negative electrode sheet 24. Alternatively, two or more of the positive electrode sheet 22, the negative electrode sheet 24, and the separator sheet 26 (in this case, the first separator sheet 26S₁ and the second separator sheet 26S₂) may include the adhesion layer 6. Furthermore, in this preferred embodiment, the adhesion layer 6 is arranged on both surfaces of the second separator sheet 26S₂. According to the above-described configuration, misalignment of the electrode sheets and the separator sheets in the wound electrode body can be more preferably prevented. In other words, a sheet having the above-described configuration is preferable as an object to which the technology disclosed herein is applied. Note that, in other preferred embodiments, the adhesion layer 6 may be arranged on only one surface of the sheet (in this case, the second separator sheet 26S₂).

In one preferred aspect, in the preparing, the adhesion layer is formed on at least one surface of at least one sheet of the above-described sheets. As illustrated in FIG. 2 and FIG. 3, in this preferred embodiment, in the preparing, the adhesion layer 6 is formed on both surfaces of the second separator sheet 26S₂. According to the above-described configuration, deterioration of the adhesion layer 6 can be suppressed and adhesive strength can be preferably secured as compared to a case where the sheet including the adhesion layer 6 provided therein in advance (in this case, the second separator sheet 26S₂) is used, and therefore, the above-described configuration is preferable.

### Step S2: Conveying

As described above, in this process step, each of the prepared sheets is conveyed as being sandwiched between the rollers 3a and 3b. In the conveying, the region where the adhesion layer 6 is not arranged in the second separator sheet 26S₂ including the adhesion layer 6 is made to contact the rollers 3a and 3b.

In one preferred aspect, in the conveying, the sheet including the adhesion layer is conveyed such that the region where the adhesion layer is arranged substantially does not contact the roller. As illustrated in FIG. 2 and FIG. 3, in this preferred embodiment, in the conveying, in the second separator sheet 26S₂ including the adhesion layer 6, the region where the adhesion layer 6 is arranged is made substantially not to contact the rollers 3a and 3b. According to the above-described configuration, adhesion of a foreign matter to the sheet (in this case, the second separator sheet 26S₂), reduction in adhesive strength of the adhesion layer 6, or the like can be particularly preferably suppressed, and therefore, the productivity of the wound electrode body and the storage device (for example, a battery) including the wound electrode body can be preferably increased.

In one aspect, the rotating surface of the roller is configured in a comb shape with a recessed portion and a raised portion alternately formed. In the conveying, the raised portion is made to contact the region where the adhesion layer is not arranged in the sheet including the adhesion layer, and the sheet including the adhesion layer is conveyed. As illustrated in FIG. 2 and FIG. 3, in this preferred embodiment, a rotating surface of the roller 3a is configured in a comb shape with a recessed portion 3a₁ and a raised portion 3a₂ alternately formed. A rotating surface of the roller 3b is configured in a comb shape with a recessed portion 3b₁ and a raised portion 3b₂ alternately formed. In the conveying, the raised portion 3a₂ and the raised portion 3b₂ are made to contact the region where the adhesion layer 6 is not arranged in the second separator sheet 26S₂ including the adhesion layer 6, and the second separator sheet 26S₂ including the adhesion layer 6 is conveyed.

In one aspect, on the sheet including the adhesion layer, the adhesion layer is intermittently arranged in the width direction of the sheet or the longitudinal direction orthogonal to the width direction, and in the conveying, the roller conveys the sheet on which the adhesion layer is arranged such that the roller contacts the region where the adhesion layer is not arranged in the sheet on which the adhesion layer is intermittently arranged. As illustrated in FIG. 2 and FIG. 3, in this preferred embodiment, on the second separator sheet 26S₂ including the adhesion layer 6, the adhesion layer 6 is intermittently arranged in the longitudinal direction of the second separator sheet 26S₂. In the conveying, the rollers 3a and 3b convey the second separator sheet 26S₂ including the adhesion layer 6 so as to contact the region where the adhesion layer 6 is not arranged in the second separator sheet 26S₂ on which the adhesion layer 6 is intermittently arranged.

### Step S3: Winding

As described above, in this process step, the conveyed positive electrode sheet 22, negative electrode sheet 24, first separator sheet 26S₁, and second separator sheet 26S₂ are wound around the winding core 4.

In one aspect, the wound electrode body includes a first separator sheet and a second separator sheet as the separator sheet, and in the winding, the first separator sheet, the positive electrode sheet, the second separator sheet, and the negative electrode sheet are stacked in this order and wound, or the first separator sheet, the negative electrode sheet, the second separator sheet, and the positive electrode sheet are stacked in this order and wound. As illustrated in FIG. 1, in this preferred embodiment, the wound electrode body includes the first separator sheet 26S₁ and the second separator sheet 26S₂ as the separator sheet 26. In the winding, the first separator sheet 265₁, the positive electrode sheet 22, the second separator sheet 26S₂, and the negative electrode sheet 24 are stacked in this order and wound. In the above-described manner, a wound body can be obtained.

In this preferred embodiment, after the winding, a process step of pressing the obtained wound body may further provided. Specifically, the wound body manufactured in the above-described manner is pulled out from the winding core 4 and is pressed by a press machine or the like. Thus, flat-shaped wound electrode bodies 20a, 20b, 20c can be preferably obtained. In other preferred embodiments, the pressing may not be provided.

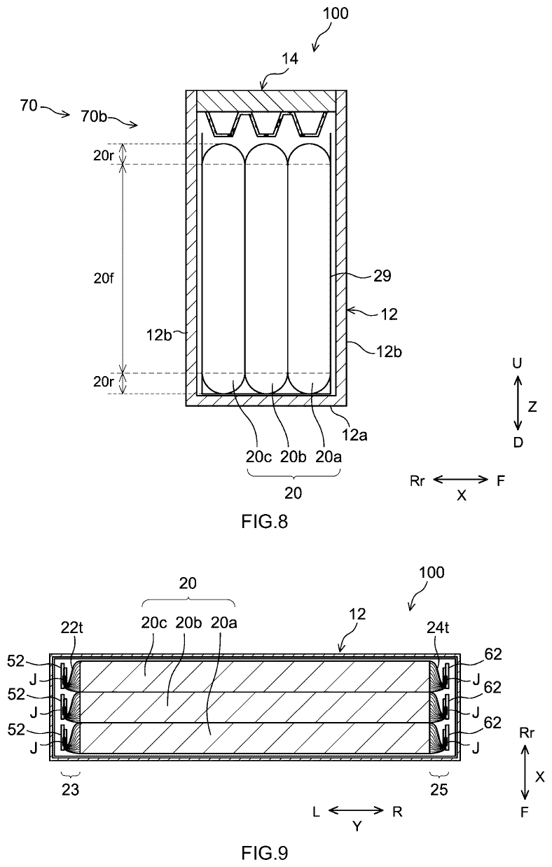

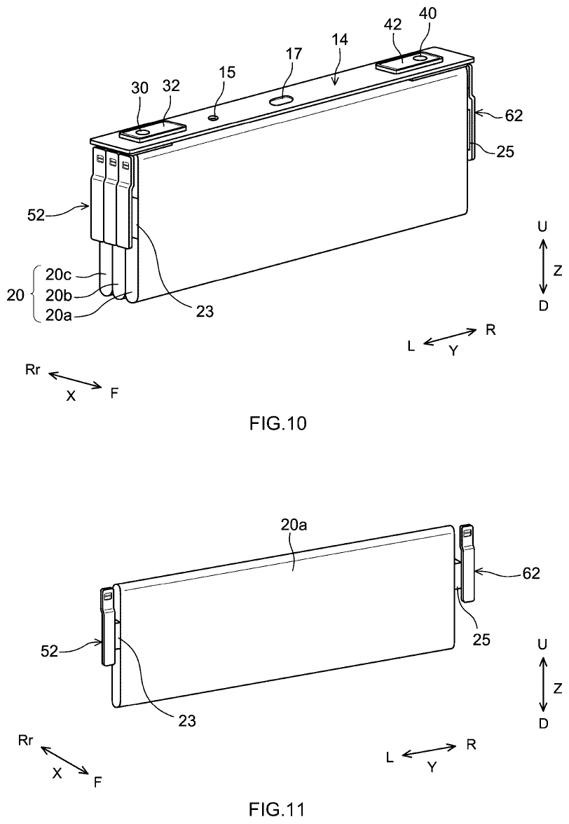

A battery 100 can be constructed using the wound electrode bodies (in this case, 20a, 20b, and 20c) obtained by the method for manufacturing a wound electrode body as described above. Specifically, the battery 100 can be manufactured by preparing the wound electrode bodies 20a, 20b, and 20c, inserting the wound electrode bodies 20a, 20b, and 20c into a battery case 10, and sealing the battery case 10. First, as illustrated in FIG. 10, a positive electrode second current collector 52 is joined to a positive electrode tab group 23 of each of the wound electrode bodies, and a negative electrode second current collector 62 is joined to a negative electrode tab group 25 thereof. Then, as illustrated in FIG. 9, the wound electrode bodies are aligned such that flat portions thereof are opposed to each other. A sealing plate 14 is arranged above the wound electrode bodies, and the positive tab group 23 of each of the wound electrode bodies is bent such that the positive electrode second current collector 52 and one side surface of the wound electrode body are opposed to each other. Thus, the positive electrode first current collector 51 and the positive electrode second current collector 52 are connected to each other. Similarly, the negative electrode tab group 25 of each of the wound electrodes is bent such that the negative electrode second current collector 62 and the other side surface 20h of the wound electrode body are opposed to each other. Thus, the negative electrode first current collector 61 and the negative electrode second current collector 62 are connected to each other. As a result, the wound electrode body is attached to the sealing plate 14 via the positive electrode current collecting section 50 and the negative electrode current collecting section 60. Next, the wound electrode bodies attached to the sealing plate 14 are covered by an electrode body holder 29 (see FIG. 8) and then are accommodated inside an exterior body 12. As a result, flat portions of the wound electrode bodies are opposed to the long side walls 12b of the exterior body 12 (that is, flat surfaces of a battery case 10). An upper curved portion 20r is opposed to the sealing plate 14, and a lower curved portion 20r is opposed to a bottom wall 12a of the exterior body 12. The battery case 10 is constructed by joining (welding) the exterior body 12 and the sealing plate 14 after closing the opening 12h in the upper surface of the exterior body 12 with the sealing plate 14. Thereafter, an electrolyte is injected into the battery case 10 through a liquid injection hole 15 in the sealing plate 14, and the liquid injection hole 15 is closed with a sealing member 15a. The battery 100 can be manufactured in the above-described manner.

### Configuration of Battery

Subsequently, the battery 100 obtained by the above-described manufacturing method will be described.

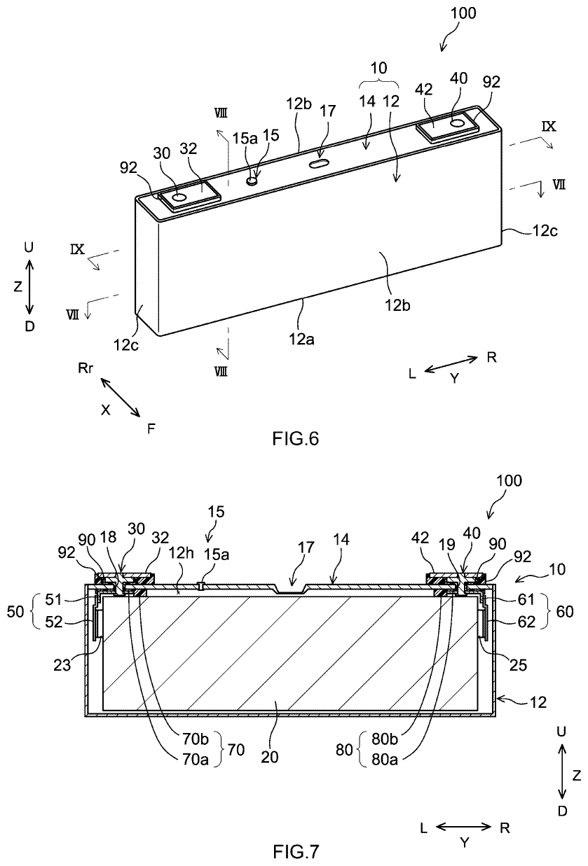

FIG. 6 is a perspective view of the battery 100. FIG. 7 is a schematic longitudinal sectional view taken along line VII-VII of FIG. 6. FIG. 8 is a schematic longitudinal sectional view taken along line VIII-VIII of FIG. 9. FIG. 9 is a schematic cross-sectional view taken along line IX-IX of FIG. 6. In the following description, reference signs L, R, F, Rr, U, and D in the drawings denote left, right, front, rear, up, and down, respectively, and reference signs X, Y, and Z in the drawings denote a short side direction of the battery 100, a long side direction thereof orthogonal to the short side direction, and an up-down direction thereof orthogonal to the short side direction, respectively. However, these directions are defined for convenience of explanation, and do not limit an installation form of the battery 100.

As illustrated in FIG. 7, the battery 100 includes a battery case (case) 10 and a wound electrode body group 20. The battery 100 according to this preferred embodiment includes, in addition to the battery case 10 and the wound electrode body group 20, a positive electrode terminal 30, a positive electrode external conductive member 32, a negative electrode terminal 40, a negative electrode external conductive member 42, an external insulating member 92, a positive electrode current collector 50, a negative electrode current collector 60, a positive electrode internal insulating member 70, and a negative electrode internal insulating member 80. Although not illustrated, the battery 100 according to this preferred embodiment further includes an electrolytic solution. The battery 100 is herein a lithium-ion secondary battery.

The battery case 10 is a housing that accommodates the wound electrode body group 20. The battery case 10 has a flat and bottomed rectangular parallelopiped (rectangle) outer shape. A conventionally used material may be used for the battery case 10, and there is no particular limitation thereon. The battery case 10 is preferably formed of a metal having a predetermined strength. Examples of a metal material forming the battery case 10 include aluminum, aluminum alloy, iron, iron alloy, or the like.

The battery case 10 includes an exterior body 12, a sealing plate 14, and a gas exhaust valve 17. The exterior body 12 is a flat rectangular container having one side formed as an opening 12h. Specifically, as illustrated in FIG. 6, the exterior body 12 includes an approximately rectangular bottom wall 12a, a pair of first side walls 12c extending upward U from short sides of the bottom wall 12a and opposed to each other, and a pair of second side walls 12b extending upward U from long sides of the bottom wall 12a and opposed to each other. An area of the first side wall 12c is smaller than an area of the second side wall 12b. The opening 12h is formed at an upper surface of the exterior body 12 surrounded by the pair of first side walls 12c and the pair of second side walls 12b. The sealing plate 14 is mounted on the exterior body 12 so as to close the opening 12h of the exterior body 12. The sealing plate 14 is an approximately rectangular plate material when viewed from top. The sealing plate 14 is opposed to the bottom wall 12a of the exterior body 12. The battery case 10 is formed by joining (for example, welding joining) the sealing plate 14 to a peripheral edge of the opening 12h of the exterior body 12. Joining of the sealing plate 14 can be performed by welding, such as, for example, laser welding or the like. Specifically, each of the pair of first side walls 12c is joined to a corresponding short side of the sealing plate 14, and each of the second side walls 12b is joined to a corresponding long side of the sealing plate 14.

As illustrated in FIG. 6 and FIG. 7, the gas exhaust valve 17 is formed in the sealing plate 14. The gas exhaust valve 17 is configured to open and discharge gas in the battery case 10 when a pressure in the battery case 10 is a predetermined value or more. The gas exhaust valve 17 in this preferred embodiment is a recessed portion that has an approximately circular shape when viewed from top and is recessed from an outer surface of the sealing plate 14 toward the wound electrode body group 20. A thin portion having a smeller thickness than a thickness of the sealing plate 14 is formed on a bottom surface of the gas exhaust valve 17. The gas exhaust valve 17 is configured such that the thin portion is broken when a case internal pressure is the predetermined value or more. Thus, the gas in the battery case 10 is discharged to outside, so that the increased case internal pressure can be reduced.

In addition to the gas exhaust valve 17, a liquid injection hole 15 and two terminal insertion holes 18 and 19 are provided in the sealing plate 14. The liquid injection hole 15 is an opening that communicates with an internal space of the exterior body 12 and is provided for injecting an electrolytic solution in a manufacturing process of the battery 100. The liquid injection hole 15 is sealed by a sealing member 15a. As the sealing member 15a, for example, a blind rivet is preferably used. Thus, the sealing member 15a can be firmly fixed inside the battery case 10. Each of the terminal insertion holes 18 and 19 is formed in a corresponding one of both end potions of the sealing plate 14 in a long side direction Y. Each of the terminal insertion holes 18 and 19 passes through the sealing plate 14 in an up-down direction Z. As illustrated in FIG. 7, the positive electrode terminal 30 is inserted in the terminal insertion hole 18 at one side (a left side) in the long side direction Y. The negative electrode terminal 40 is inserted in the terminal insertion hole 19 at the other side (a right side) in the long side direction Y.

FIG. 10 is a perspective view schematically illustrating the wound electrode body group 20 mounted on the sealing plate 14. In this preferred embodiment, a plurality of (in this case, three) wound electrode bodies 20a, 20b, and 20c are accommodated in the battery case 10. Note that there is no particular limitation on a number of the wound electrode bodies accommodated in one battery case 10, and the number of the wound electrode bodies may be one and may be two or more (plural). Note that, as illustrated in FIG. 7, the positive electrode current collector 50 is arranged on one side of each wound electrode body in the long side direction Y (a left side in FIG. 7) and the negative electrode current collector 60 is arranged on the other side thereof in the long side direction Y (a right side in FIG. 7). The wound electrode bodies 20a, 20b, and 20c are connected in parallel. However, the wound electrode bodies 20a, 20b, and 20c may be connected in series. The wound electrode body group 20 is herein accommodated in the exterior body 12 of the battery case 10 in a state of being covered by an electrode body holder 29 (see FIG. 8) formed of a resin sheet.

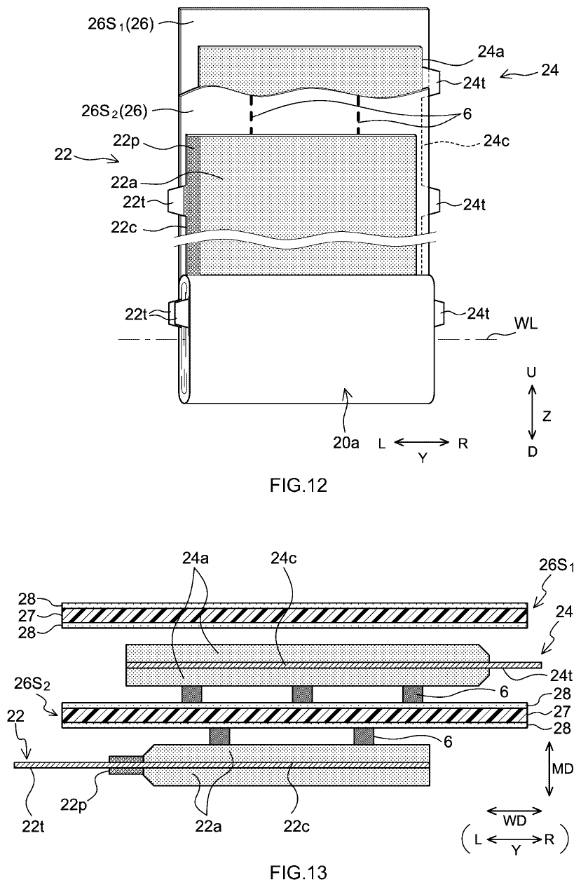

FIG. 12 is a perspective view schematically illustrating the wound electrode body 20a. Note that, although the wound electrode body 20a will be described in detail below as an example, each of the wound electrode body 20b and the wound electrode body 20c can be formed in a similar configuration.

As illustrated in FIG. 12, the wound electrode body 20a includes the positive electrode sheet 22, the negative electrode sheet 24, and the separator sheet 26. The wound electrode body 20a is herein a wound electrode body configured such that the strip-shaped positive electrode sheet 22 and the strip-shaped negative electrode sheet 24 are stacked with two separator sheets 26 interposed therebetween and an obtained stacked body is wound around a winding axis WL as a center.

The wound electrode body 20a has a flat shape. The wound electrode body 20a is arranged in the exterior body 12 such that the winding axis WL extends approximately in parallel to the long side direction Y. Specifically, as illustrated in FIG. 8, the wound electrode body 20a includes a pair of curved portions (R portions) 20r opposed to the bottom wall 12a of the exterior body 12 and the sealing plate 14 and a flat portion 20f that connects the pair of curved portions 20r and is opposed to the first side walls 12b of the case body 12. The flat portion 20f extends along the second side walls 12b.

As illustrated in FIG. 12, the positive electrode sheet 22 includes a positive electrode current collector 22c, a positive electrode active material layer 22a and a positive electrode protective layer 22p that are fixed to at least one surface of the positive electrode current collector 22c. However, the positive electrode protective layer 22p is not essential and can be omitted in other preferred embodiments. The positive electrode current collector 22c has a strip shape. The positive electrode current collector 22c is formed of a conductive metal, such as, for example, aluminum, aluminum alloy, nickel, stainless steel, or the like. The positive electrode current collector 22c is a metal foil, specifically, an aluminum foil, herein.

A plurality of positive electrode tabs 22t are provided in one end portion of the positive electrode current collector 22c in the long side direction Y (a left end portion in FIG. 12). The plurality of positive electrode tabs 22t are provided at intervals (intermittently) in a longitudinal direction of the strip-shaped positive electrode sheet 22. Each of the plurality of positive electrode tabs 22t protrudes outward from the separator sheet 26 toward one side (a left side in FIG. 12) in an axis direction of the winding axis WL. Note that the positive electrode tabs 22t may be provided at the other end portion in the axis direction of the winding axis WL (a right side when indicated in FIG. 12), and may be provided at each of both sides in the axis direction of the winding axis WL. The positive electrode tab 22t is a portion of the positive electrode current collector 22c and is formed of a metal foil (an aluminum foil). However, the positive electrode tab 22t may be a separate member from the positive electrode current collector 22c. The positive electrode active material layer 22a and the positive electrode protective layer 22p are not formed in at least a portion of the positive electrode tab 22t, and a region where the positive electrode current collector 22c is exposed is formed in the portion.

As illustrated in FIG. 9, the plurality of positive electrode tabs 22t are stacked in the one end portion in the axis direction of the winding axis WL (a left end portion in FIG. 9) to form a positive electrode tab group 23. Each of the plurality of positive electrode tabs 22t is bent such that respective outer side ends thereof are aligned. Thus, an accommodation property into the battery case 10 can be increased, and a size of the battery 100 can be reduced. As illustrated in FIG. 7, the positive electrode tab group 23 is electrically connected to the positive electrode terminal 30 via the positive electrode current collector 50. Specifically, the positive electrode tab group 23 and the positive electrode second current collector 52 are connected at a connection portion J (see FIG. 9). The positive electrode second current collector 52 is electrically connected to the positive electrode terminal 30 via a positive electrode first current collector 51. Note that respective sizes of the plurality of positive electrode tabs 22t (a length in the long side direction Y and a width orthogonal to the long side direction Y, see FIG. 12) can be adjusted as appropriate, for example, in accordance with a forming position or the like, considering a state of being connected to the positive electrode current collector 50. Herein, the respective sizes of the plurality of positive electrode tabs 22t are different from each other such that the respective outer side ends thereof are aligned when being bent.

As illustrated in FIG. 12, the positive electrode active material layer 22a is provided in a strip shape to extend in the longitudinal direction of the strip-shaped positive electrode current collector 22c. The positive electrode active material layer 22a includes a positive electrode active material (for example, lithium-transition metal compound oxide, such as lithium nickel cobalt manganese composite oxide or the like) that can reversibly store and release a charge carrier. When it is assumed that an entire solid content of the positive electrode active material layer 22a is 100 mass %, the positive electrode active material may occupy generally 80 mass % or more, typically 90 mass % or more, and, for example, 95 mass % or more. The positive electrode active material layer 22a may include an optional component, such as, for example, a conductive material, a binder, various additive components, or the like, in addition to the positive electrode active material. As the conductive material, a carbon material, such as, for example, acetylene black (AB) or the like, can be used. As the binder, for example, polyvinylidene fluoride (PVdF) or the like can be used.

As illustrated in FIG. 12, the positive electrode protective layer 22p is provided in a boundary portion between the positive electrode current collector 22c and the positive electrode active material layer 22a in the long side direction Y. Herein, the positive electrode protective layer 22p is provided in one end portion of the positive electrode current collector 22c in the axis direction of the winding axis WL (the left end portion in FIG. 12). However, the positive electrode protective layer 22p may be provided in both end portions of the positive electrode current collector 22c in the axis direction. The positive electrode protective layer 22p is provided in a strip shape to extend along the positive electrode active material layer 22a. The positive electrode protective layer 22p includes an inorganic filler (for example, alumina). When it is assumed that an entire solid content of the positive electrode protective layer 22p is 100 mass %, the inorganic filler may occupy generally 50 mass % or more, typically 70 mass % or more, and, for example, 80 mass % or more. The positive electrode protective layer 22p may include an optional component, such as, for example, a conductive material, a binder, various additive components, or the like, in addition to the inorganic filler. The conductive material and the binder may be the same as those described above as examples that can be included in the positive electrode active material layer 22a.

As illustrated in FIG. 12, the negative electrode sheet 24 includes a negative electrode current collector 24c and a negative electrode active material layer 24a fixed to at least one surface of the negative electrode current collector 24c. The negative electrode current collector 24c has a strip shape. The negative electrode current collector 24c is formed of a conductive metal, such as, for example, copper, copper alloy, nickel, stainless steel, or the like. The negative electrode current collector 24c is a metal foil, specifically, a copper foil herein.

A plurality of negative electrode tabs 24t are provided in one end portion of the negative electrode current collector 24c in the axis direction of the winding axis WL (a right end portion in FIG. 12). The plurality of negative electrode tabs 24t are provided at intervals (intermittently) in a longitudinal direction of the strip-shaped negative electrode 24. Each of the plurality of negative electrode tabs 24t protrudes outward from the separator 26 toward one side in the axis direction (a right side in FIG. 12). However, the negative electrode tabs 24t may be provided at the other end portion in the axis direction (a left end portion in FIG. 12), and may be provided at each of both sides in the axis direction. The negative electrode tab 24t is a portion of the negative electrode current collector 24c and is formed of a metal foil (a copper foil). However, the negative electrode tab 24t may be a separate member from the negative electrode current collector 24c. The negative electrode active material layer 24a is not formed at least in a portion of the negative electrode tab 24t, and a region where the negative electrode current collector 24c is exposed is provided in the portion.

As illustrated in FIG. 9, the plurality of negative electrode tabs 24t are stacked in the one end portion in the axis direction (a right end portion in FIG. 9) to form a negative electrode tab group 25. The negative electrode tab group 25 is preferably provided in a position symmetrical to the positive electrode tab group 23 in the axis direction. Each of the plurality of negative electrode tabs 24t is bent such that respective outer side ends thereof are aligned. Thus, the accommodation property into the battery case 10 can be increased, and the size of the battery 100 can be reduced. As illustrated in FIG. 7, the negative electrode tab group 25 is electrically connected to the negative electrode terminal 40 via the negative electrode current collector 60. Specifically, the negative electrode tab group 25 and the negative electrode second current collector 62 are connected at a connection portion J (see FIG. 9). The negative electrode second current collector 62 is electrically connected to the negative electrode terminal 40 via a negative electrode first current collector 61. Similar to the plurality of positive electrode tabs 22t, herein, respective sizes of the plurality of negative electrode tabs 24t are different from each other such that the respective outer side ends thereof are aligned when being bent.

As illustrated in FIG. 12, the negative electrode active material layer 24a is provided in a strip shape to extend in the longitudinal direction of the strip-shaped negative electrode current collector 24c. The negative electrode active material layer 24a includes a negative electrode active material (for example, a carbon material, such as graphite or the like) that can reversibly store and release a charge carrier. When it is assumed that an entire solid content of the negative electrode active material layer 24a is 100 mass %, the negative electrode active material may occupy generally 80 mass % or more, typically 90 mass % or more, and, for example, 95 mass % or more. The negative electrode active material layer 24a may include an optional component, such as, for example, a binder, a dispersant, various additive components, or the like, in addition to the negative electrode active material. As the binder, rubbers, such as, for example, styrene butadiene rubber (SBR) or the like, can be used. As the dispersant, celluloses, such as, for example, carboxymethyl cellulose (CMC) or the like, can be used.

The separator sheet 26 is a strip-shaped member, as illustrated in FIG. 12 and FIG. 3. The separator sheet 26 is an insulating sheet in which a plurality of micro through-holes through which the charge carrier can pass are formed. A width of the separator sheet 26 is larger than a width of the negative electrode active material layer 24a. With the separator sheet 26 provided between the positive electrode sheet 22 and negative electrode sheet 24, the positive electrode sheet 22 and the negative electrode sheet 24 can be prevented from contacting each other and the charge carrier (for example, lithium ions) can be moved between the positive electrode sheet 22 and the negative electrode sheet 24. Although not particularly limited, a thickness of the separator sheet 26 (a length thereof in a stacking direction MD in FIG. 13, the same applied hereinafter) is preferably 3 μm or more, and is more preferably 5 μm or more. Moreover, the thickness of the separator sheet 26 is preferably 25 μm or less, is more preferably 18 μm or less, and is further more preferably 14 μm or less.

Herein, two separator sheets 26 are used for one wound electrode body 20a. It is preferable that, as in this preferred embodiment, one wound electrode body 20a includes two separator sheets 26, that is, a first separator and a second separator. Herein, the two separators have different configurations, but may have the same configuration. However, in other preferred embodiments, one wound electrode body 20a may include only one separator sheet 26. In such a case, for example, the positive electrode sheet 22 including an insulating layer on each of both surfaces thereof, the negative electrode sheet 24, and the separator sheet 26 may be stacked in this order.

Herein, FIG. 13 is an enlarged view schematically illustrating an interface between the positive electrode sheet 22, the negative electrode sheet 24, and separator sheet 26 according to this preferred embodiment. As illustrated in FIG. 13, the separator sheet 26 according to this preferred embodiment includes a base material layer 27 and a heat resistance layer (HRL) 28 provided on one surface of the base material layer 27. The adhesion layer 6 is present on a surface of the heat resistance layer 28.

As the base material layer 27, a conventionally known microporous film used for a separator of a battery can be used without any particular limitation. The base material layer 27 is preferably a porous sheet-like member. The base material layer 27 may have a single-layer structure and may be a multilayer structure including two or more layers, for example, a three-layer structure. The base material layer 27 is preferably formed of a polyolefin resin. The entire base material layer 27 is preferably formed of a polyolefin resin. The base material layer 27 is preferably a microporous film formed of, for example, polyethylene. Thus, flexibility of the separator sheet 26 can be sufficiently ensured, and manufacturing (wounding and press-forming) of the wound electrode body 20a can be easily performed. As the polyolefin resin, polyethylene (PE), polypropylene (PP), or a mixture thereof is preferable, and the base material layer 27 is more preferably formed of PE.

Although not particularly limited, a thickness of the base material layer 27 (a length thereof in the stacking direction MD, the same applied hereinafter) is preferably 3 μm or more, and is more preferably 5 μm or more. Moreover, the thickness of the base material layer 27 is preferably 25 μm or less, is more preferably 18 μm or less, and is further more preferably 14 μm or less. A gas permeability of the base material layer 27 is preferably 30 sec/100 cc to 500 sec/100 cc, is more preferably 30 sec/100 cc to 300 sec/100 cc, and is further more preferably 50 sec/100 cc to 200 sec/100 cc.

The heat resistance layer 28 is provided on the base material layer 27. The heat resistance layer 28 is preferably formed on the base material layer 27. The heat resistance layer 28 may be provided directly on a surface of the base material layer 27, and may be provided on the base material layer 27 via some other layer. The heat resistance layer 28 is preferably formed on one surface or both surfaces of the base material layer 27. However, the heat resistance layer 28 is not essential, and can be omitted in other preferred embodiments. The heat resistance layer 28 is herein provided on an entire surface of the base material layer 27 opposed to the positive electrode sheet 22. Thus, thermal contraction of the separator sheet 26 can be more appropriately suppressed, and the above-described configuration can contribute to increase of safety of the battery 100. A basis weight of the heat resistance layer 28 is herein uniform in a longitudinal direction LD of the separator sheet 26 and in a winding axis direction WD. Although not particularly limited, a thickness of the heat resistance layer 28 (a length thereof in the stacking direction MD, the same applied hereinafter) is preferably 0.3 μm or more, is more preferably 0.5 μm or more, and is further more preferably 1 μm or more. Moreover, the thickness of the heat resistance layer 28 is preferably 6 μm or less, and is more preferably 4 μm or less. The heat resistance layer 28 preferably includes an inorganic filler and a heat resistance layer binder.

As the inorganic filler, a conventionally known inorganic filler used for this type of application can be used without any particular limitation. The inorganic filler preferably contains insulative ceramic particles. Among such inorganic fillers, considering heat resistance, easy availability, or the like, inorganic oxide, such as alumina, zirconia, silica, titania, or the like, metal hydroxide, such as aluminum hydroxide or the like, or cray mineral, such as boehmite or the like, is preferably used, and alumina and boehmite are more preferably used. From a viewpoint of suppressing thermal contraction of the separator sheet 26, the inorganic filler is particularly preferably formed of a compound containing aluminum. A ratio of the inorganic filler to a total mass of the heat resistance layer 28 is preferably 85 mass % or more, is more preferably 90 mass % or more, and is further more preferably 95 mass % or more.

As the heat resistance layer binder, a conventionally known binder used for this type of application can be used without any particular limitation. Specific examples of the heat resistance layer binder include acrylic resin, fluororesin (for example, PVdF), epoxy resin, urethane resin, ethylene-vinyl acetate resin, or the like. Among the above-described materials, acrylic resin is preferable.

As illustrated in FIG. 13, in this preferred embodiment, the adhesion layer 6 is provided on a surface opposed to the positive electrode sheet 22 and a surface opposed to the negative electrode sheet 24 and contacts the positive electrode sheet 22 and the negative electrode sheet 24. As illustrated in FIG. 13, the adhesion layer 6 is preferably formed on at least the surface of the separator sheet 26 at a side of the positive electrode sheet 22. Herein, the adhesion layer 6 is provided on the heat resistance layer 28. The adhesion layer 6 is preferably provided on the heat resistance layer 28. The adhesion layer 6 may be provided directly on a surface of the heat resistance layer 28, and may be provided on the heat resistance layer 28 via some other layer. The adhesion layer 6 may be provided directly on a surface of the base material layer 27, and may be provided on the base material layer 27 via some other layer than the heat resistance layer 28. The adhesion layer 6 has a relatively high affinity with an electrolytic solution, for example, as compared to the heat resistance layer 28, and can absorb the electrolytic solution to swell. Although not particularly limited, a thickness of the adhesion layer 6 (a length thereof in the stacking direction MD in FIG. 13) in the wound electrode body 20a is preferably 0,1 μm or more, is more preferably 0.2 μm or more, and is further more preferably 0.5 μm or more. Moreover, the thickness of the adhesion layer 6 is preferably 10 μm or less, is more preferably 5 μm or less, and is further more preferably 3 μm or less. That is, the thickness of the adhesion layer 6 in the wound electrode body 20a is preferably, for example, in a range of 0.1 μm to 10 μm.

The adhesion layer 6 includes an adhesion layer binder. As the adhesion layer binder, a conventionally known resin material having constant viscosity with respect to the positive electrode sheet 22 can be used without any particular limitation. Specific examples of the adhesion layer binder include acrylic resin, fluororesin, epoxy resin, urethane resin, ethylene-vinyl acetate resin, polyallylamine (PM) resin, cellulose resin, such as carboxymethyl cellulose (CMC) or the like, or the like. Among the above-described materials, fluororesin and acrylic resin are preferable since each of fluororesin and acrylic resin has a high flexibility and can more preferably exhibit adhesiveness to the positive electrode sheet 22. Examples of fluororesin include polyvinylidene fluoride (PVdF), polytetrafluoroethylene (PTFE), or the like. A type of the adhesion layer binder may be the same as the heat resistance layer binder, and may be different from the heat resistance layer binder. A ratio of the adhesion layer binder to a total mass of the adhesion layer 6 is preferably 20 mass % or more, is more preferably 50 mass % or more, and is further more preferably 70 mass % or more. Thus, predetermined adhesiveness can be appropriately exhibited on the positive electrode sheet 22, and the separator sheet 26 can be easily deformed in press-forming.

The adhesion layer 6 may include, in addition to the adhesion layer binder, some other material (for example, the inorganic filler described as a component of the heat resistance layer 28 above, or the like). When the adhesion layer 6 includes the inorganic filler, a ratio of the inorganic filler to the total mass of the adhesion layer 6 is preferably 80 mass % or less, is more preferably 50 mass % or less, and is further more preferably 30 mass % or less.

As illustrated in FIG. 12, in this preferred embodiment, the adhesion layer 6 is intermittently arranged in the longitudinal direction of the second separator sheet 26S₂. In this preferred embodiment, the adhesion layer 6 is arranged in a dashed line shape on a line extending in the longitudinal direction of the second separator sheet 26S₂. Note that a shape of the adhesion layer 6 is not limited thereto, and the adhesion layer 6 may be formed, for example, in a dot shape, a stripe shape, a wave shape, a strip shape (a streak shape), or a shape obtained by combining the above-described shapes in a plan view of the separator sheet 26.

The electrolytic solution may be similar to an electrolytic solution conventionally used, and there is no particular limitation thereto. The electrolytic solution is, for example, a nonaqueous electrolytic solution including a nonaqueous solvent and a supporting salt. The nonaqueous solvent includes carbonates, such as, for example, ethylene carbonate, dimethyl carbonate, ethyl methyl carbonate, or the like. The supporting salt is a fluorine-containing lithium salt, such as, for example, LiPF₆ or the like. However, the electrolytic solution may be in a solid form (a solid electrolyte) and may be integrated with the wound electrode body group 20.

As illustrated in FIG. 7, the positive electrode terminal 30 is inserted in the terminal insertion hole 18 formed in one end portion of the sealing plate 14 in the long side direction Y (a left end portion in FIG. 7). The positive electrode terminal 30 is preferably formed of a metal, and is more preferably formed of, for example, aluminum or aluminum alloy. On the other hand, the negative electrode terminal 40 is inserted in the terminal insertion hole 19 formed in the other end portion of the sealing plate 14 in the long side direction Y (a right end portion in FIG. 7). Note that the negative electrode terminal 40 is preferably formed of a metal, and is more preferably formed of, for example, copper or copper alloy. Herein, each of the electrode terminals (the positive electrode terminal 30 and the negative electrode terminal 40) protrudes from the same surface of the battery case 10 (specifically, the sealing plate 14). However, the positive electrode terminal 30 and the negative electrode terminal 40 may be formed to protrude from different surfaces of the battery case 10. The electrode terminals (the positive electrode terminal 30 and the negative electrode terminal 40) inserted into the terminal insertion hole 18 and the terminal insertion hole 19, respectively, are preferably fixed to the sealing plate 14 by a caulking work or the like.

As described above, the positive electrode terminal 30 is electrically connected to the positive electrode sheet 22 of each of the wound electrode bodies 20a, 20b, and 20c (see FIG. 12) via the positive electrode current collector 50 (the positive electrode first current collector 51 and the positive electrode second current collector 52) in the exterior body 12, as illustrated in FIG. 7. The positive electrode terminal 30 is insulated from the sealing plate 14 by the positive electrode internal insulating member 70 and the gasket 90. Note that the positive electrode internal insulating member 70 includes a base portion 70a arranged between the positive electrode first current collector 51 and the sealing plate 14 and a protruding portion 70b protruding from the base portion 70a toward the wound electrode body 20a. The positive electrode terminal 30 exposed to outside of the battery case 10 through the terminal insertion hole 18 is connected to the positive electrode external conductive member 32 outside the sealing plate 14. On the other hand, as illustrated in FIG. 7, the negative electrode terminal 40 is electrically connected to the negative electrode sheet 24 of each of the wound electrode bodies 20a, 20b, and 20c (see FIG. 12) via the negative electrode current collector 60 (the negative electrode first current collector 61 and the negative electrode second current collector 62) in the exterior body 12. The negative electrode terminal 40 is insulated from the sealing plate 14 by the negative electrode internal insulating member 80 and the gasket 90. Note that, similar to the positive electrode internal insulating member 70, the negative electrode internal insulating member 80 includes a base portion 80a arranged between the negative electrode first current collector 61 and the sealing plate 14 and a protruding portion 80b protruding from the base portion 80a toward the wound electrode body 20a. The negative electrode terminal 40 exposed to outside of the battery case 10 through the terminal insertion hole 19 is connected to the negative electrode external conductive member 42 outside the sealing plate 14. The external insulating member 92 is arranged between each of the external conductive members (the positive electrode external conductive member 32 and the negative electrode external conductive member 42) described above and an outer surface of the sealing plate 14. The external conductive members 32 and 42 can be insulated from the sealing plate 14 by the external insulating member 92.

In the up-down direction, the protruding portions 70b and 80b of the internal insulating members (the positive electrode internal insulating member 70 and the negative electrode internal insulating member 80) described above are arranged between the sealing plate 14 and the wound electrode body 20a. With the protruding portions 70b and 80b of the internal insulating members, upward movement of the wound electrode body 20a is restricted, and the sealing plate 14 and the wound electrode body 20a can be prevented from contacting each other.

### Application of Battery

The battery 100 can be used for various applications, and can be preferably used as a power source (a drive power source) for a motor mounted on a vehicle, such as, for example, a passenger vehicle, a truck, or the like. There is no particular limitation on a vehicle type. Examples of the vehicle type include, for example, a plug-in hybrid electric vehicle (PHEV), a hybrid electric vehicle (HEV), a battery electric vehicle (BEV), or the like. In the battery 100, variations in battery reaction are reduced, and therefore, the battery 100 can be preferably used for constructing an assembled battery.

One preferred embodiment of the present disclosure has been described above, but the preferred embodiment (the first embodiment) is merely an example. The present disclosure can be implemented in various other embodiments. The present disclosure can be carried out based on contents disclosed in this specification and the common general technical knowledge in the field. The technology described in the scope of claims includes various modifications and changes of the preferred embodiment described as an example above. For example, a portion of the preferred embodiment described above can be replaced with some other modified aspect. Some other modified aspect can be added to the preferred embodiment described above. Additionally, a technical feature can be deleted as appropriate unless the technical feature is described as an essential element.

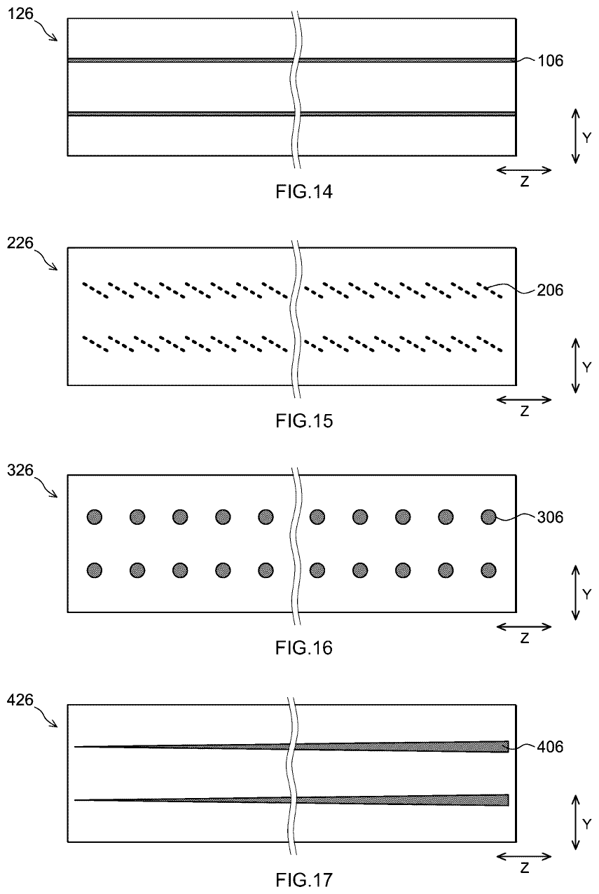

For example, FIG. 14 is a diagram according to a second preferred embodiment, corresponding to FIG. 2. As illustrated in FIG. 14, in the second preferred embodiment, in a plan view of a sheet (in this case, a second separator sheet 126), an adhesion layer 106 is arranged in a strip shape (a streak shape) on a line extending in the longitudinal direction. The second preferred embodiment may be similar to the first preferred embodiment described above, except for the above-described pattern change.

For example, FIG. 15 is a diagram according to a third preferred embodiment, corresponding to FIG. 2. As illustrated in FIG. 15, in the third preferred embodiment, in a plan view of a sheet (in this case, a second separator sheet 226), an adhesion layer 206 is arranged as inclined dashed lines arranged in the longitudinal direction. The third preferred embodiment may be similar to the first preferred embodiment described above, except for the above-described pattern change.

For example, FIG. 16 is a diagram according to a fourth preferred embodiment, corresponding to FIG. 2. In the fourth preferred embodiment, in a plan view of a sheet (in this case, a second separator sheet 326), an adhesion layer 306 is arranged as dots arranged in the longitudinal direction. The fourth preferred embodiment may be similar to the first preferred embodiment described above, except for the above-described pattern change.

For example, FIG. 17 is a diagram according to a fifth preferred embodiment, corresponding to FIG. 2. In the fifth preferred embodiment, in a plan view of a sheet (in this case, a second separator sheet 426), an adhesion layer 406 is arranged in a strip shape (a streak shape) a width of which gradually increases in the longitudinal direction. The fifth preferred embodiment may be similar to the first preferred embodiment described above, except for the above-described pattern change.

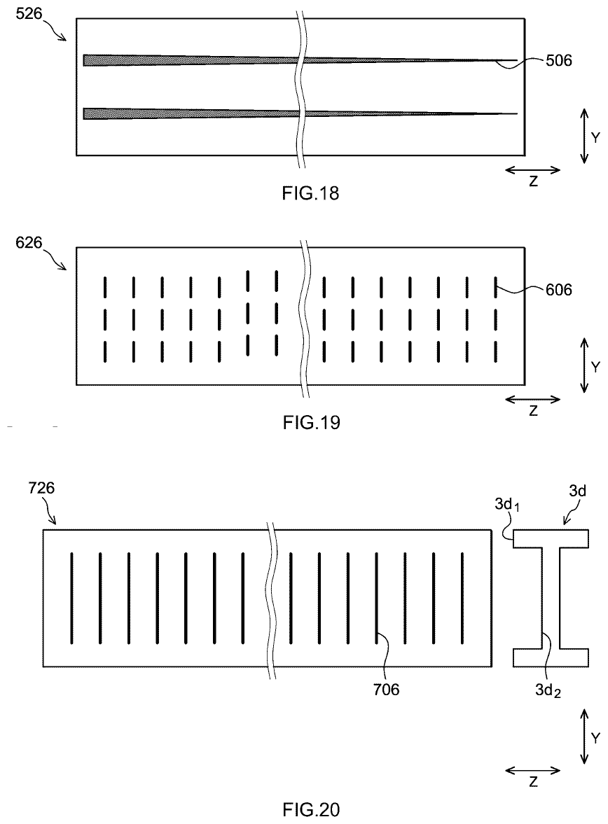

For example, FIG. 18 is a diagram according to a sixth preferred embodiment, corresponding to FIG. 2. In the sixth preferred embodiment, in a plan view of a sheet (in this case, a second separator sheet 526), an adhesion layer 506 is arranged in a strip shape (a streak shape) a width of which gradually reduces in the longitudinal direction. The sixth preferred embodiment may be similar to the first preferred embodiment described above, except for the above-described pattern change.

For example, FIG. 19 is a diagram according to a seventh preferred embodiment, corresponding to FIG. 2. In the seventh preferred embodiment, in a plan view of a sheet (in this case, a second separator sheet 626), an adhesion layer 606 is intermittently arranged (on a line extending in the transverse direction) in the width direction. The seventh preferred embodiment may be similar to the first preferred embodiment described above, except for the above-described pattern change.

For example, FIG. 20 is a diagram according to an eighth preferred embodiment, corresponding to FIG. 2. In the eighth preferred embodiment, in a plan view of a sheet (in this case, a second separator sheet 726), an adhesion layer 706 is arranged in a strip shape (a streak shape) to extend in the width direction. The eighth preferred embodiment may be similar to the first preferred embodiment described above, except for the above-described pattern change. Note that, in the eighth preferred embodiment, a rotating surface of a roller 3d preferably has a raised portion 3d₁ configured to contact a region where the adhesion layer 706 is not provided in the sheet (in this case, the separator sheet 726) including the adhesion layer 706. Furthermore, the rotating surface of a roller 3d preferably has a recessed portion 3d₂ configured such that a region where the adhesion layer 706 is arranged in the sheet (in this case, the separator sheet 726) including the adhesion layer 706 and the roller 3d substantially do not contact each other.

As described above, the following items are given as specific aspects of the technology disclosed herein.

First Item: A method for manufacturing a wound electrode body, the wound electrode body being configured such that a strip-shaped positive electrode sheet and a strip-shaped negative electrode sheet are stacked with a strip-shaped separator sheet interposed therebetween and an obtained stacked body is wound and that the separator sheet and the positive electrode sheet are bonded via an adhesion layer and/or the separator sheet and the negative electrode sheet are bonded via the adhesion layer, the method including preparing the positive electrode sheet, the negative electrode sheet, and the at least one separator sheet, conveying each of the prepared sheets, and winding each of the conveyed sheets around a winding core, being configured such that, in the preparing, at least one sheet of the positive electrode sheet, the negative electrode sheet, and the separator sheet includes the adhesion layer on at least one surface thereof and the surface including the adhesion layer includes a region where the adhesion layer is arranged and a region where the adhesion layer is not arranged, and in the conveying, the sheet including the adhesion layer is conveyed such that the region where the adhesion layer is not arranged contacts a roller.
Second Item: The method for manufacturing a wound electrode body according to the first item 1, in which, in the conveying, the sheet including the adhesion layer is conveyed such that the region where the adhesion layer is arranged substantially does not contact the roller.
Third Item: The method for manufacturing a wound electrode body according to the first or second item, in which, in the preparing, the adhesion layer is formed on at least one surface of at least one sheet of the positive electrode sheet, the negative electrode sheet, and the separator sheet.
Fourth Item: The method for manufacturing a wound electrode body according to any one of the first to third items, in which the sheet including the adhesion layer is the separator sheet.
Fifth Item: The method for manufacturing a wound electrode body according to the fourth item, in which the adhesion layer is arranged on both surfaces of the separator sheet.
Sixth Item: The method for manufacturing a wound electrode body according to any one of the first to fifth items, in which the wound electrode body includes, as the separator sheet, a first separator sheet and a second separator sheet, and in the winding, the first separator sheet, the positive electrode sheet, the second separator sheet, and the negative electrode sheet are stacked in this order and wound or the first separator sheet, the negative electrode sheet, the second separator sheet, and the positive electrode sheet are stacked in this order and wound.
Seventh Item: The method for manufacturing a wound electrode body according to any one of the first to sixth items, in which a rotating surface of the roller is configured in a comb shape with a recessed portion and a raised portion alternately formed, and in the conveying, the sheet including the adhesion layer is conveyed such that the raised portion contacts the region where the adhesion layer is not arranged in the sheet including the adhesion layer.
Eighth Item: The method for manufacturing a wound electrode body according to any one of the first to seventh items, in which, on the sheet including the adhesion layer, the adhesion layer is intermittently arranged in a width direction of the sheet or a longitudinal direction orthogonal to the width direction, and in the conveying, the sheet including the adhesion layer is conveyed such that the roller contacts the region where the adhesion layer is not arranged in the sheet on which the adhesion layer is intermittently arranged.
Ninth Item: A method for manufacturing a storage device, in which a storage device is constructed using a wound electrode body obtained by the method for manufacturing a wound electrode body according any one of the first to eighth items.
Tenth Item: A wound electrode body manufacturing device for a wound electrode body configured such that a strip-shaped positive electrode sheet and a strip-shaped negative electrode sheet are stacked with a strip-shaped separator sheet interposed therebetween and an obtained stacked body is wound and that the separator sheet and the positive electrode sheet are bonded via an adhesion layer and/or the separator sheet and the negative electrode sheet are bonded via the adhesion layer, the device including a conveying section that conveys the positive electrode sheet, the negative electrode sheet, and the separator sheet, a roller configured to contact a region where the adhesion layer is not arranged in one sheet of the positive electrode sheet, the negative electrode sheet, and the separator sheet that includes the adhesion layer, and a winding core around which the sheets conveyed by the conveying section are wound.
Eleventh Item: The wound electrode body manufacturing device according to the tenth item, in which the roller is configured substantially not to contact the region where the adhesion layer is arranged in the sheet including the adhesion layer.
Twelfth Item: The wound electrode body manufacturing device according to the tenth or eleventh item, further including an adhesion layer application section used for arranging the adhesion layer on at least one surface of at least one sheet of the positive electrode sheet, the negative electrode sheet, and the separator sheet.
Thirteenth Item: The device according to any one of the first to twelfth items, in which a rotating surface of the roller is configured in a comb shape with a recessed portion and a raised portion alternately formed, and the raised portion contacts the region where the adhesion layer is not arranged in the sheet including the adhesion layer.
Fourteenth Item: The wound electrode body manufacturing device according to any one of the tenth to thirteenth items, in which, on the sheet including the adhesion layer, the adhesion layer is intermittently arranged in a width direction of the sheet or a longitudinal direction orthogonal to the width direction, and the roller is configured to contact the region where the adhesion layer is not arranged in the sheet on which the adhesion layer is intermittently arranged.

Although the preferred embodiments of the present application have been described thus far, the foregoing preferred embodiments are only illustrative, and the present application may be embodied in various other aspects. The present application may be practiced based on the disclosure of this specification and technical common knowledge in the related field. The techniques described in the claims include various changes and modifications made to the preferred embodiments illustrated above. Any or some of the technical features of the foregoing preferred embodiments, for example, may be replaced with any or some of the technical features of variations of the foregoing preferred embodiments. Any or some of the technical features of the variations may be added to the technical features of the foregoing preferred embodiments. Unless described as being essential, the technical feature(s) may be optional.
1 Wound electrode body manufacturing device
2 Conveying section
3a, 3b, 3c Roller
4 Winding core
5 Adhesion layer application section
6 Adhesion layer
10 Battery case
12 Exterior body
14 Sealing plate
15 Liquid injection hole
15a Sealing member
17 Gas exhaust valve
18, 19 Terminal insertion hole
20 Electrode body group
20a to 20c Wound electrode body
22 Positive electrode sheet
23 Positive electrode tab group
24 Negative electrode sheet
25 Negative electrode tab group
26 Separator sheet
27 Base material layer
28 Heat resistance layer
30 Positive electrode terminal
32 Positive electrode external conductive member
40 Negative electrode terminal
42 Negative electrode external conductive member
50 Positive electrode current collector
60 Negative electrode current collector
70 Positive electrode internal insulating member
80 Negative electrode internal insulating member
90 Gasket
92 External insulating member
100 Battery

What is claimed is:

1. A method for manufacturing a wound electrode body, the wound electrode body being configured such that a strip-shaped positive electrode sheet and a strip-shaped negative electrode sheet are stacked with a strip-shaped separator sheet interposed therebetween and an obtained stacked body is wound and that the separator sheet and the positive electrode sheet are bonded via an adhesion layer and/or the separator sheet and the negative electrode sheet are bonded via the adhesion layer, the method comprising:
preparing the positive electrode sheet, the negative electrode sheet, and the at least one separator sheet;
conveying each of the prepared sheets; and
winding each of the conveyed sheets around a winding core,
wherein
in the preparing, at least one sheet of the positive electrode sheet, the negative electrode sheet, and the separator sheet includes the adhesion layer on at least one surface thereof and the surface including the adhesion layer includes a region where the adhesion layer is arranged and a region where the adhesion layer is not arranged, and
in the conveying, the sheet including the adhesion layer is conveyed such that the region where the adhesion layer is not arranged contacts a roller.

2. The method for manufacturing a wound electrode body according to claim 1, wherein
in the conveying, the sheet including the adhesion layer is conveyed such that the region where the adhesion layer is arranged substantially does not contact the roller.

3. The method for manufacturing a wound electrode body according to claim 1,
wherein
in the preparing, the adhesion layer is formed on at least one surface of at least one sheet of the positive electrode sheet, the negative electrode sheet, and the separator sheet.

4. The method for manufacturing a wound electrode body according to claim 1,
wherein
the sheet including the adhesion layer is the separator sheet.

5. The method for manufacturing a wound electrode body according to claim 4,
wherein
the adhesion layer is arranged on both surfaces of the separator sheet.

6. The method for manufacturing a wound electrode body according to claim 1,
wherein
the wound electrode body includes, as the separator sheet, a first separator sheet and a second separator sheet, and
in the winding, the first separator sheet, the positive electrode sheet, the second separator sheet, and the negative electrode sheet are stacked in this order and wound or the first separator sheet, the negative electrode sheet, the second separator sheet, and the positive electrode sheet are stacked in this order and wound.

7. The method for manufacturing a wound electrode body according to claim 1,
wherein
a rotating surface of the roller is configured in a comb shape with a recessed portion and a raised portion alternately formed, and
in the conveying, the sheet including the adhesion layer is conveyed such that the raised portion contacts the region where the adhesion layer is not arranged in the sheet including the adhesion layer.

8. The method for manufacturing a wound electrode body according to claim 1,
wherein
on the sheet including the adhesion layer, the adhesion layer is intermittently arranged in a width direction of the sheet or a longitudinal direction orthogonal to the width direction, and
in the conveying, the sheet including the adhesion layer is conveyed such that the roller contacts the region where the adhesion layer is not arranged in the sheet on which the adhesion layer is intermittently arranged.

9. A method for manufacturing a storage device,
wherein, a storage device is constructed using a wound electrode body obtained by the method for manufacturing a wound electrode body according to claim 1.

10. A wound electrode body manufacturing device for a wound electrode body configured such that a strip-shaped positive electrode sheet and a strip-shaped negative electrode sheet are stacked with a strip-shaped separator sheet interposed therebetween and an obtained stacked body is wound and that the separator sheet and the positive electrode sheet are bonded via an adhesion layer and/or the separator sheet and the negative electrode sheet are bonded via the adhesion layer, the device comprising:
a conveying section that conveys the positive electrode sheet, the negative electrode sheet, and the separator sheet;
a roller configured to contact a region where the adhesion layer is not arranged in one sheet of the positive electrode sheet, the negative electrode sheet, and the separator sheet that includes the adhesion layer; and
a winding core around which the sheets conveyed by the conveying section are wound.

11. The wound electrode body manufacturing device according to claim 10,
wherein
the roller is configured substantially not to contact the region where the adhesion layer is arranged in the sheet including the adhesion layer.

12. The wound electrode body manufacturing device according to claim 10, further comprising:
an adhesion layer application section used for arranging the adhesion layer on at least one surface of at least one sheet of the positive electrode sheet, the negative electrode sheet, and the separator sheet.

13. The wound electrode body manufacturing device according to claim 10,
wherein
a rotating surface of the roller is configured in a comb shape with a recessed portion and a raised portion alternately formed, and
the raised portion contacts the region where the adhesion layer is not arranged in the sheet including the adhesion layer.

14. The wound electrode body manufacturing device according to claim 10,
wherein
on the sheet including the adhesion layer, the adhesion layer is intermittently arranged in a width direction of the sheet or a longitudinal direction orthogonal to the width direction, and
the roller is configured to contact the region where the adhesion layer is not arranged in the sheet on which the adhesion layer is intermittently arranged.
